(19) United States
(12) Patent Application Publication
(10) Pub. No.: US 2015/0374586 A1
(43) Pub. Date: Dec. 31, 2015

(54) TABLET PRESS

(71) Applicant: Michael GAMLEN, Beckenham (GB)

(72) Inventor: Michael Gamlen, Beckenham (GB)

(21) Appl. No.: 14/411,462

(22) PCT Filed: Jun. 26, 2013
(86) PCT No.: PCT/GB2013/051696

§ 371 Date: Dec. 26, 2014

(30) Foreign Application Priority Data
Jun. 26, 2012 (GB) 1211305.6

(51) Int. Cl. A61J 3/10; B30B 11/10; B30B 15/02; B30B 11/00; B30B 11/04

(52) U.S. Cl. CPC A61J 3/10; B30B 11/005; B30B 11/04; B30B 15/022; B30B 11/10

(57) ABSTRACT

The invention concerns a tablet press system, typically for production of small batches of tablets. The system comprises a die for receiving a powder to be compacted and a press member for compacting the powder in use within the die, the press member being actuable along a first axis under the control of an electronic controller. The die is moveable between a first location in which the die is aligned with the first axis for compaction and at least one further location spaced therefrom. The system may comprise a plurality of stations and a die guide to allow motion of the die between a filling and compaction station under control of the controller. The press member may be electrically actuated by a motor under electronic control.

The present invention relates to a tablet press system and more particularly, although not exclusively, to a press system for use in producing pharmaceutical tablets.

The large-scale production of tablets typically involves the use of tablet punches which operate to compact a volume of powder located in a die. The powder in the die is held between opposing punches which move together by a predetermined distance of travel to produce a tablet of controlled thickness within a die of known geometry. This is such that the formed tablet has a known or determinable density according to the die geometry and volume of powder used but there is no direct control of the force applied to the tablet during the compaction process.

The mass production of tablets requires that the movement of the punches and/or applied load is known in advance such that a tabletting machine can be set to reproduce tablets consistently. Such machines typically allow for cyclic loading of multiple punches such that tablets can be produced continually to known production rates. A conventional machine comprises a rotary press/punch configuration and a settable gearing mechanism so as to apply compaction pressure in a generally sinusoidal profile. Although the specific mechanics of different machinery may vary, such principles are generally accepted as being industry-standard.

Tabletting machines may be configured for either batch runs or continuous operation according to the above principles. In either case, the desire for repeatability in the compression process generally dictates that a rotary punch actuation configuration is used for large scale manufacturing.

Research into tablet formulations and production processes requires relatively small scale production and testing of tablets. An iterative approach to tablet production and testing is generally needed in order to converge on a satisfactory tablet formulation and corresponding compaction process.

Whilst smaller-scale tabletting machines, typically suited to batch production, are available in industry, such machines generally mimic the cyclic, rotary operation of their larger counterparts. Such machines are often provided with sensing equipment and associated software so that they can be used as compaction simulators for prediction of larger scale production parameters. Those machines are typically expensive, bulky and may require time-consuming setup procedures before production can be undertaken. Furthermore the batch sizes for which those machines are suited may be larger than is required for research work or other small-scale production.

It is an aim of the present invention to provide a tablet press which better provides for relatively small scale or ad hoc production.

The present invention may be considered to derive from the general principle of providing a relatively small and low cost tablet press that offers improved user control over individual or relatively small batch production of tablets.

According to the present invention, there is provided a tablet press system comprising a die for receiving a powder to be compacted and a press member for compacting the powder in use within the die, the press member being actuable along a first axis, wherein the die is moveable between a first location in which the die is aligned with the first axis for compaction and at least one further location.

The first location may comprise a compacting/pressing location or station.

The further location may comprise any or any combination of a filling, weighing and/or a tablet removal (e.g. ejection) location. The first and further location(s) may be spaced in the direction of movement or travel of the die. Any, or any combination, of the further location(s) may comprise a filling, weighing and/or tablet removal station.

The die may be moveable in a direction of travel that is substantially perpendicular (or otherwise angled) to the first axis. The freedom of motion of the die may be constrained to one or two dimensions. The die may be translatable, for example in a plane which may be substantially perpendicular (or otherwise angled) to the first axis. The die may be constrained to linear/axial motion.

The first and further locations/stations may be spaced by 10 cm or greater.

The tablet press may comprise a die guide. The die guide may comprise one or more elongate guide formation, such as a rail, runner or similar formation. The die may have a single degree of freedom of motion along the die guide or guide formation. The die guide may take the form of a track.

The guide formation itself may be straight or curved. The die may be constrained between a pair of opposing die guide formations.

The die guide may extend between the first and further location(s). The die guide may connect the first and further location(s). The first and further location(s) may be spaced by the die guide. In the event that a plurality of further locations are provided, the first and further locations may be provided in a predetermined order or sequence along the die guide. In any example, the die guide may provide a closed track, circuit or loop between the first and further location(s).

The die may be actuable either manually or else by way of a die actuator. The die movement may be electrically powered. The die actuator may comprise an electric actuator, such as an electric motor. A DC motor may be used. The die actuator may alternatively comprise a fluid drive, such as a pneumatic or hydraulic actuator.

The die movement may be automatically controlled, for example by a controller. The controller may be arranged to move the die between the first axis and one or more further stations in use, for example in a predetermined sequence.

The system may comprise one or more position determining means or sensors. The first location may comprise a die location sensor, such as a pressure sensor, proximity sensor, light sensor or the like. One or more sensors may be provided at each location/station. One or more further sensors may be provided to determine the presence/absence/volume and/or compaction state of material in the die.

The output of the one or more sensor may be communicated to the controller. The controller may control the motion of the die in dependence on the output of the one or more sensor. The sensor may comprise one or more die location sensor, press member position sensor, weight sensor (e.g. a powder or die weight sensor), and/or a compaction load sensor. The controller may receive any or any combination of readings from said sensors in order to control movement of the die in relation thereto. The controller may control or actuate the die according to a feedback control scheme or loop, such as an open or closed feedback loop.

The die guide may comprise one or more stop or abutment formation. A first stop formation may be provided to define a location in which the die is aligned with the first axis. A further stop formation may be provided at one or more of the further stations.

The system may comprise one or more lock member for releasably locking the die at the first and/or further location.

The die may be moveable in a circular and/or reciprocal (e.g. back and forth) manner between the first and further location(s).

The filling station may comprise a powder dispenser, which may be aligned with a further axis. The further axis may be substantially parallel with the first axis. The filling station may comprise a powder reservoir or hopper. The powder dispenser may comprise a powder pipette.

The die may have an open end, through which the die is both filled and compacted. The die opening may be aligned with a die axis. The die axis may be aligned with the first axis in the first location and may be aligned with one or more further axis in one or more further location.

The tablet press may comprise a base. The die may be held relative to the base. The base may comprise the die guide(s) and/or a stop or lock member for the die guide.

The press member may be held relative to the base by a spacer. The spacer may depend from the base and may be moveable relative thereto under the control of a press actuator. The spacer may comprise one or more arm or pillar formations. A pair of spaced, generally parallel spacers may be provided, typically with the press member being arranged there-between. The spacer may comprise a plurality of arm or pillar formations which may move uniformly in response to operation of the actuator.

The press member may reversibly actuable between an at-rest condition in which the press member is spaced from the die and an actuated condition in which the press member is located in the die so as to apply a load to a powder therein.

The arrangement of the present invention may provide for a compact and lightweight machine which can be used to manufacture relatively small numbers or batches of tablets in a semi-automated or automated fashion, whilst still allowing the flexibility to change the tablet make-up or compaction parameters simply between batches.

The tablet press system may comprise a “benchtop” system. Preferably the first and further station(s) are portable and can be assembled in a spaced relationship with the die guide running there-between.

The press member may be electrically actuated by an actuator. According to one embodiment, the press actuator comprises an electric motor, which may comprise a DC motor. The motor may comprise a brushed motor. In other embodiments, an alternative electrically powered actuator could be provided, such as a solenoid.

In one embodiment, the press actuator comprises a controller, which may comprise an electrical or electronic controller, such as a microcontroller. The press actuator controller and die movement controller may be one and the same or else may comprise a plurality of interconnected controllers/processors. The controller may allow for digital control of the press actuator, which may be achieved using one or more of a number of control parameters such as force, displacement or location. The press actuator may be controlled by the controller based upon a preset control scheme or one or more desired value of an operation variable input by a user. The combination of an electronic, or digital, controller and an electric actuator is particularly beneficial in providing for a highly configurable/controllable desktop press.

The controller may control the actuator(s) to undergo a single pressing cycle, or a small number of pressing cycles, in response to a user input. The user input may comprise any or any combination of: a desired volume/mass of powder; a desired applied load to the powder; a desired tablet thickness; and/or a desired number of tablets to be produced. The controller may determine and/or modify pressing cycle parameters in accordance with a desired tablet characteristic, which may be input for example by an operator. The pressing cycle or actuation parameter determined by the controller may comprise any, or any combination, of a pressing load, a distance of travel or end position of the press member, a duration of pressing and/or a speed of travel of the press member.

The, or each, pressing cycle may comprise a pressing stage, during which a tablet is formed, and a tablet ejection stage. The pressing stage may comprise movement of the press member into the actuated condition followed by retraction there-from. The retraction may be to a return or at-rest condition. The ejection stage may comprise actuation of the press member into the die such that it contacts the tablet formed therein so as to dislodge the tablet from the die. The ejection stage may comprise opening a floor portion of the die for ejection of the tablet.

The actuator may drive the press member at a variable speed. The speed of press member actuation may be controlled by the controller, for example by application of a constant speed or fixed acceleration/deceleration profile, or else by dynamic speed control, for example based upon one or more sensed operational parameters, such as the load applied by the press member.

The press actuator may be arranged to drive the press member in a first, or compaction, direction and a second, or reverse, direction. The actuator may drive the press member in the first direction up to a predetermined condition. The condition may be a stop condition and may be determined by the location of the press member and/or load applied by, or to, the press member. The location of the press member may be determined relative to a datum point and/or the position of the die. Upon determination of the stop condition, the controller may control the press actuator to cease actuation of the press member in the first direction. The actuator may cease actuation for a predetermined time and/or enter a reverse operation mode in which the press member is moved in a reverse direction.

The tablet press system may comprise a load sensor for determining the load applied to material within the die. The load sensor may comprise a load cell. The load sensor may be arranged in the force path between the press actuator and press member. For example the load sensor may be located in the force path between the spacer and the press member. The controller may record the maximum load on the press member in the actuation condition or during a compaction cycle. The controller may log the load on the press member at a plurality of times during a compaction cycle.

The controller may receive or determine the location or travel distance of the press member. The controller may receive or determine the load on the press member. The controller may record data for the press member position and/or load at predetermined time intervals or positions. The recorded data or a part thereof may be output on a graphic display, for example on a screen and/or on a printout. Recorded data may be plotted as a graphical output. The controller may also determine the ejection load required to dislodge or eject the tablet from the die once formed.

In one embodiment, the base and/or die comprises a powder guide member, such as, for example, a funnel or chute. The powder guide member may depend from an open end of the die.

The die may comprise a die floor portion and an intermediate member having a recess or bore therein for reception of powder in use. The intermediate member may comprise an upstanding, typically tubular, member or portion of the die. The die floor and intermediate member may cooperate to define a die formation having a closed end. The die floor portion and intermediate member may be arranged for selective relative movement. The die floor may comprise a slider member arranged for movement relative to the intermediate member between a compaction condition and a tablet ejection condition. The die floor may comprise an opening which is offset from the intermediate member recess in the compaction condition and which is aligned with the intermediate member recess in the ejection condition.

In any embodiment, a plurality of dies may be provided. The dies may travel along the die guide between the first and further locations. The dies may be located at the first and further locations concurrently, for example so as to allow the process of forming successive tablets to be expedited. Any of the preferable features described above in relation to any one die may be applied any of the plurality of dies.

The controller may control movement of plurality of dies between locations/stations based upon any one or more of the sensor readings discussed above.

A tablet removal station may comprise a tablet reservoir or container into which a plurality of tablets (such as a small batch) of tablets can be deposited before cessation of the tablet production. The tablet removal station may be located between the filling station and the pressing station.

Separate filling and weighing stations may be provided. The weighing station may be provided between the filling station and the pressing station such that a weight of powder in the die may be checked prior to compaction. In another example, the filling and weighing functions may be performed at a single station.

The present invention is particularly useful for research work or other small scale manufacture since it allows tablets to be produced individually or in small numbers, wherein the compaction load and/or dimensions of each tablet are known upon production. This is particularly useful when testing or evaluating different tablet formulations and compaction loads to determine a setup required to achieve a tablet having suitable mechanical properties. Such properties can affect the mechanical strength or hardness of the tablet as well as the tablet uniformity and the rate at which a tablet can disintegrate/dissolve in use. Furthermore such a system may be particularly useful in the production of small batches of tablets, for example for fulfilling personalised medicine preparations or other drug or healthcare related prescriptions.

According to a further aspect of the invention there is provided a method of, typically small scale, tablet production, comprising filling a die with a predetermined volume of powder at a filling station, translating the die between the filling station and a press via a die guide and compacting the powder by insertion of said press in to the die, wherein, upon retraction of the press, the die is translated away from the press the die guide.

Any of the preferable features described herein in relation to the first aspect may be applied to the method of the second aspect and vice versa.

Working embodiments of the invention are described in further detail below with reference to the accompanying drawings, of which:

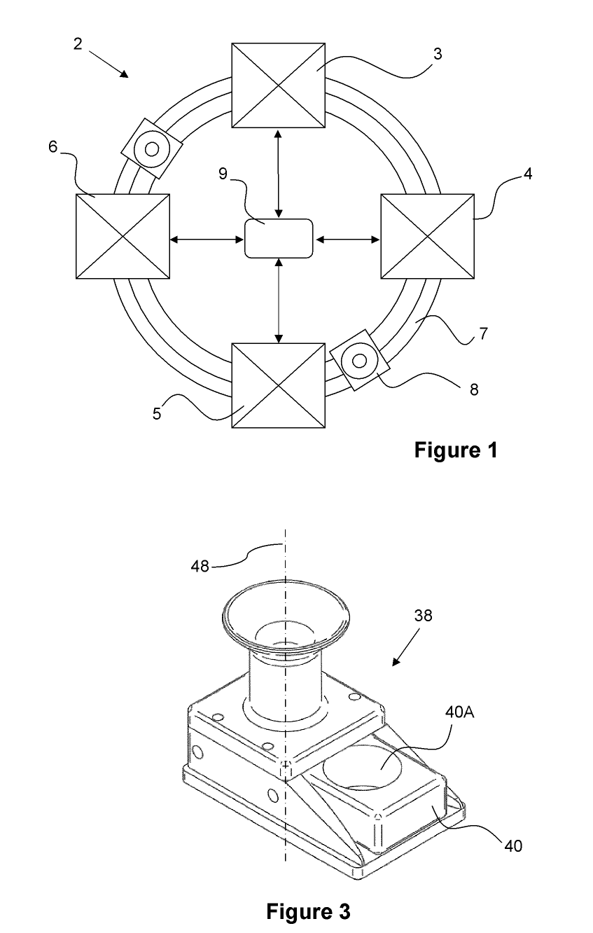

FIG. 1 shows a schematic plan view of a system according to one example of the invention;

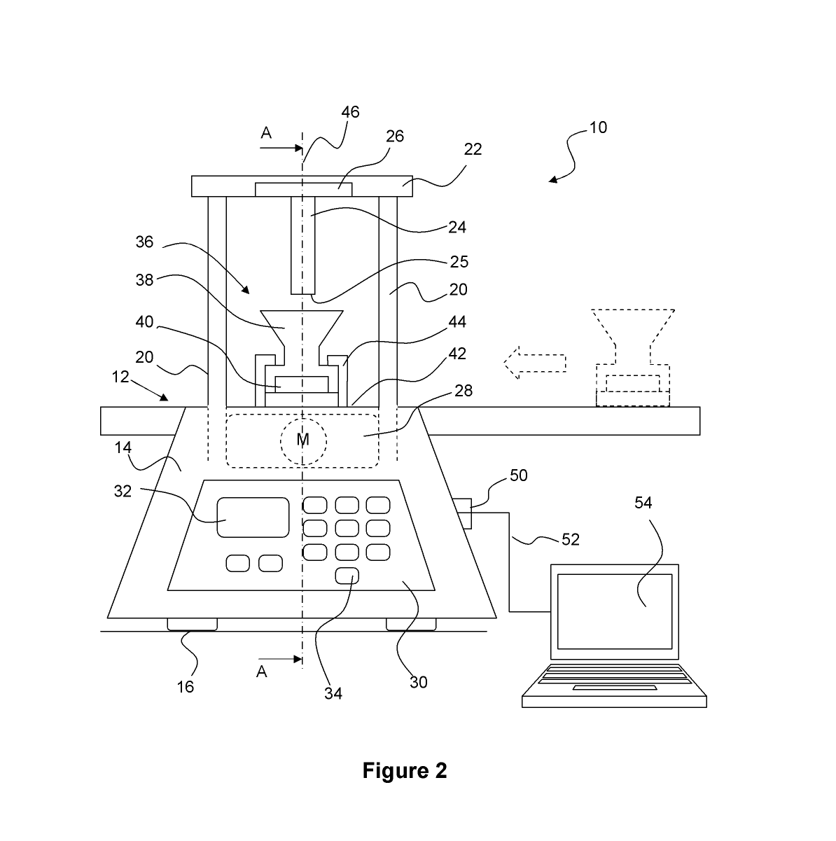

FIG. 2 shows a front view of a tablet press for use in a system according to an example of the present invention;

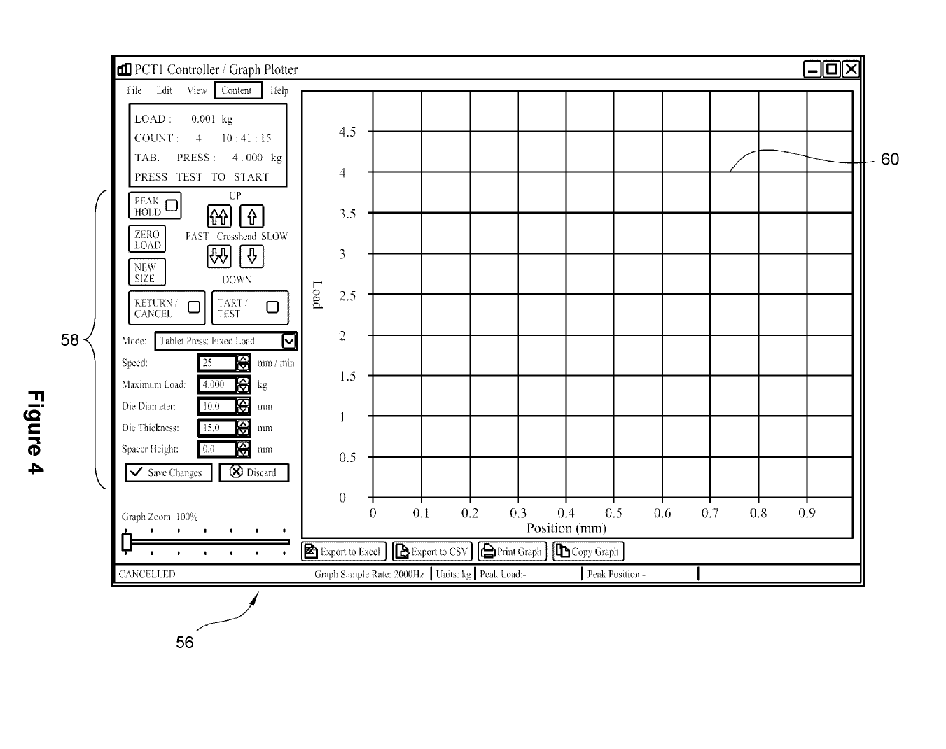

FIG. 3 shows an example of an individual die for use in conjunction with a system according to an example of the present invention;

FIG. 4 shows a graphical user interface for control and/or reporting of the tablet press according to one embodiment of the invention; and

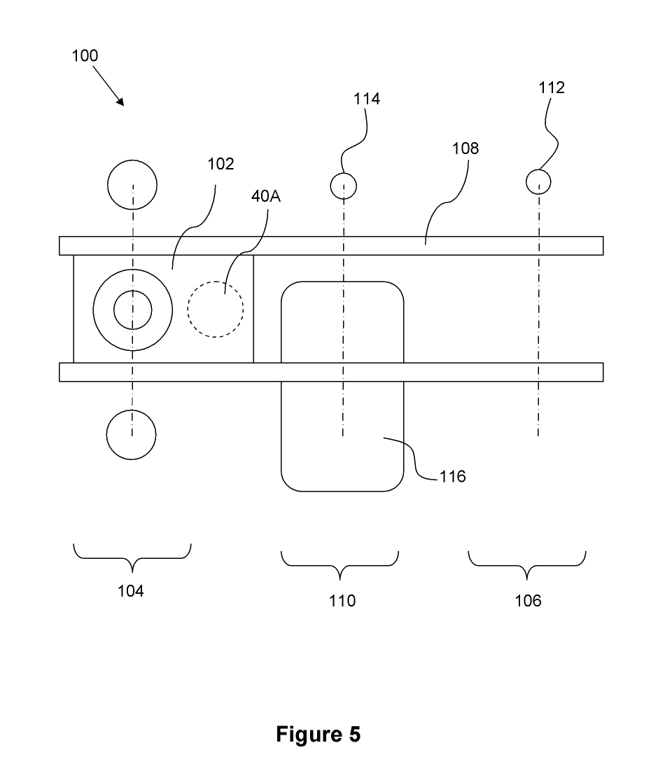

FIG. 5 shows a schematic view of a system layout according to a further example of a system according to the invention.

Turning to FIG. 1, there is shown an example of a system 2 for producing tablets either individually or in relatively small batch numbers. The system is particularly well suited to the production of batch sizes tens of tablets or less, although the system may be used to produce individual tablets or larger batch sizes if necessary.

The system 2 comprises a plurality of stations 3-6 connected by a guide 7 so as to allow movement of one or more carriages 8 between the stations along the guide 7. The stations each comprise equipment for performing different steps involved in the production of tablets from an initial powder material as will be described below. In this example the carriages 8 comprise individual dies for the formation of tablets therein such that the dies can be moved from station to station in sequence to produce tablets.

The guide takes the form of a closed loop or circuit such that the dies 8 can travel around the loop in a common direction in moving from station to station. This allows different operations to be performed on different dies concurrently by the stations 3-6 and can thereby increase the speed with which multiple tablets can be produced. In this example the guide takes the form of an elongate guide such as a track but may otherwise comprise a runner, a rail, a pair of rails or similar arrangement, along which a die carriage can travel in a constrained manner. To this end, the die carriage will typically comprise a slider or a wheeled arrangement to permit movement along the guide with relatively low friction. In an embodiment in which close control of the carriage position is required, the guide may comprise a toothed rail or rack and the die carriage may comprise a gear wheel or pinion.

Each die carriage 8 typically comprises a drive mechanism, which may take the form of an electric motor for moving the die carriages along the guide 7. A power source may provide power to the guide which may comprise a conductor for supplying power to the individual die carriages 8, e.g. by brushes on the carriages or similar, as they pass along the guide in use. Various other drive arrangements are possible as would be understood by the skilled person, such as for example a conveyor system or similar, whereby the die carriages are passively pushed or pulled around the system as required. Whilst independent control of the movements of each individual die carriage is preferred, it is not essential to the operation of the system.

The stations comprise: a compaction/pressing station 3; a die filling station 4; a weighing or weight checking station 5; and, a tablet ejection station 6. The relevant position or sequence of those stations is important in order to achieve a circuit through which the die carriages can complete successive cycles. However it will be appreciated that different systems may allow the carriages to move in a different sense (i.e. in either a clockwise or anticlockwise direction as shown in FIG. 1).

In other embodiments, the compaction 3 and ejection 6 stations could be combined in a single station as will be described below (e.g. whereby a punch performs both the compaction and ejection strokes). Also it is possible to combine the filling 4 and weighing 5 stations in a single station if necessary. Hence the system according to the invention may comprise two or more stations as necessary.

One or more controller 9 is arranged to control movements of the die carriages 8 along the guide 7 in accordance with a control strategy and the output of sensors positions about the system for determining the location(s) of the die carriage(s) and/or the operational status of the stations 3-6. The controller may take the form of a bespoke system controller or else a personal computer or other general purpose processing means with machine-readable instructions for the control of the system in accordance with the control strategy.

Further details of the stations 3-6 and the operation of the system is provided below by way of example only.

Turning firstly to FIG. 2, there is shown an example of the compaction station 3 in the form of a tablet press 10 having a base 12, which comprises a base housing 14. A lower region of the base 12 has feet 16 arranged to support the weight of the tablet press 10 on a suitable surface 18 for use.

In the upper surface of the housing 14 there are provided a plurality of openings 19, through which spacer arms, in the form of pillars 20, extend. The pillars 20 have a lower end which is located within the base housing 14 and an opposing upper end which protrudes above the base housing 14. The pillars 20 are arranged generally vertically when the feet 16 are on a horizontal surface 18.

At the upper end of the pillars 20, there is provided a support member 22 which extends between the pillars and which is arranged generally perpendicular to the longitudinal axes of the pillars. Mounted to the support member 22, there is provided a press member, which is referred to herein as punch 24. The punch 24 depends from the support member 22 at a location between, and typically equidistant from, the pillars 20. The punch 24 is elongate in form and extends towards the base 12 in a direction which is generally parallel with the pillars 20.

The punch is generally cylindrical in shape although other shapes are possible including oval, square or other shapes to which tablets are conventionally formed. The punch has a free end 25 which is blunt. The free end 25 defines in part the shape of a tablet formed by the tablet press 10 in use. Accordingly the free end may be flat or curved in a desired tablet profile. In this regard, it may be possible to provide the punch with interchangeable end sections to suit different tablet shapes. In such embodiments, the die shape will typically be interchangeable to correspond with the punch shape.

The support member 22 comprises a load sensor in the form of a load cell 26 arranged intermediate the punch 24 and the remainder of the support member. The punch 24, at its fixed end, may be mounted at or on the load cell 26, which may itself be mounted in a correspondingly shaped recess or formation in the support member. In alternative embodiments, the load sensor may be located in an alternative position, such as, for example, in the base 12 or elsewhere in the force path between the motor and base.

The support pillars 20 terminate at their lower ends within the base housing 14. Mounted within the base housing 14 is an electric motor assembly 28, which, in this embodiment, comprises a conventional brushed DC motor. However it will be understood that other types of motor may be used, such as, for example, brushless DC motors, including stepper motors. An electric motor is in many ways preferred as a suitable drive means for the tablet press due to the range of travel required by the pillars 20. However it should be noted that other forms of electromechanical drive or actuator could be considered provided they can allow for suitable linear displacement of the pillars 20 in use. In a further or alternative embodiment, feedback to the motor is provided, for example using a linear variable displacement transformer (LVDT)

The motor assembly 28 is shown schematically in FIG. 2 in cooperation with the pillars 20. Various configurations for uniformly driving the pillars 20 by the motor assembly 28 may be employed. For example the lower ends of the pillars 20 may be connected to a common cross member (not shown) and the motor 28 may be arranged to actuate the cross member such that the pillars are simultaneously driven by a single motor.

In this embodiment, the motor assembly 28 further comprises a linear servo amplifier which powers the motor. A digital encoder is also provided for the control of the motor. In this embodiment the encoder is an integral part of the motor assembly 28 within the base housing 14. Thus, in use, the angular position of the motor is determinable and digitally controllable as will be described in further detail below.

A user interface 30 is provided, for example on a panel of the base housing 14, and comprises a display screen 32 and a plurality of keys 32 in the form of a keypad. The keys allow for alphanumeric character entry by a user in a conventional manner. The controller 9 may be provided in the base, or in communication therewith, such that the user interface 30 may provide a central user interface for controlling the entire system.

On the upper portion of the base housing 14, there is sown a die carriage assembly 36 comprising a die member 38 and a die floor or base 40. The die carriage is releasably held in position against an upper surface 42 of the base 12 by retaining formations 44. The guide 7 passes through, and is supported at least in part by, the base 12 such that the die carriage assembly 36 can pass over/through the tablet press 10 in use

The pillars 20 and punch 24 are generally symmetrically arranged about axis 46 which is also the direction of travel of the punch 24 in use. The axis 46 is thus a central axis of the punch 24. In the orientation shown, the axis 46 is generally vertically aligned.

A force path can be defined between the motor assembly 28, the pillars 20, the support member 22, including the load cell 26, and punch 24. Accordingly a load applied by the motor can be communicated to the punch 24 such that the punch applies a load to powder in the die. Any reaction to the applied load experience by the punch 24 can be recorded by the load cell 26. The motor 28 and load cell 26 are typically arranged to allow for a load of up to approximately 500 kg or 4900 N.

Turning now to FIG. 3, further details of the die assembly 36 are shown. A lower portion of the die member 38 is shaped to provide a recess in which the die floor 40 is closely received. The die floor is slidable in the recess in use. In this regard, the lower portion of the die member 38 in cross section generally takes the form of an inverted channel or U-shaped formation. The die floor 40 is insertable in the channel of between the side walls thereof.

An upper portion of the die member 38 is shaped to define the die in which a tablet is formed in use. The upper portion has an upstanding wall which is generally tubular or toroidal in shape and has a central opening axis 48 into which powder can be inserted.

The uppermost end of the die 38 of the die comprises an open ended funnel formation which is aligned with the axis 48. The funnel has an upwardly facing open mouth which tapers towards a narrow opening which leads into the bore of the die section.

The die floor 40 is elongate in form and has an opening 40A part way along its length. The opening 40A takes the form of a through hole. The opening 40A has a width or diameter which is slightly larger than that of the die 38B. In the tablet-forming condition, as shown in FIG. 3, the opening 40A is offset from the die such that the die is closed at its lower end. The die floor 40 can be actuated in use to align the opening 40A with the die axis 48 and thereby allow ejection of a tablet from the die 38 once formed.

Returning now to FIG. 1, the weighing station 5 comprises digital weighing equipment (e.g. scales) of a conventional type to allow weighing of the die carriage assembly in filled and/or unfilled conditions.

The filling station 4 is provided at a location along the die guide spaced from the compaction station 3. The filling station comprises a powder reservoir and a powder dispenser. In one example, the powder dispenser may take the form of a powder pipette which may be charged with powder and discharged into the die. In such an arrangement the powder dispenser is moveable in a guided manner between a filling position and a dispensing position. In the filling position, the dispenser can receive powder from the reservoir. In the dispensing position, the dispenser moves to a position above the die for ejection/release of the powder into the die opening.

However in another embodiment, which is in many ways preferred, a metered powder delivery system is provided which allows powder to be dispensed into the die in a controlled manner (i.e. at a controlled rate).

In any embodiment, the filling station may itself comprise digital weighing equipment for weighing the powder prior to dispensing the powder into the die. Additionally or alternatively the filling station may weigh the die upon entry to the filling station in an empty state and may monitor of check the weight of the die during/after a filling operation in order to confirm the desired weight of powder is contained therein. Such a weight check-in and/or check-out procedure for the die is preferred in order to ensure tablets are formed with a required degree of accuracy and certainty.

The tablet ejection station 6 provides a receptacle in which multiple tablets can be dispensed and retained until a batch has been completed. The ejection station in this embodiment comprises a removable receptacle that is releasably mounted to the station

The operation of the system shown in FIGS. 1-3 will now be described in further detail. An operator first sets the desired tablet production parameters, a desired number of tablets to be produced and/or a desired mass/volume of powder to be dispensed into the die for each tablet. In addition, an operator may also set a number of user-changeable variables as will be described below.

An empty die assembly is first weighed at station 5. The weight is recorded and the die passes to filling station 4, where powder is poured or otherwise inserted into the die 38 and rests on the die floor member 40. Once the intended volume/weight of powder has been dispensed, the die assembly passes back to the weighing station 5, where the weight of the filled die is checked prior to the die assembly passing to the compaction station 3.

At the compaction station, one or more position sensors check that the die axis 48 is correctly aligned with the punch axis 46. The pillars are then actuated by the motor 28 to displace the punch 24 downward towards the die member 38 in the direction of the axis 46. The punch end 25 enters the die and applies a load to the powder therein so as to compact the powder into a tablet. The use of spaced pillars helps to ensure accurate axial displacement of the punch 24.

Once the tablet is formed the motor assembly actuates the pillars 20 in the reverse direction such that the punch 24 is retracted clear of the die.

The die floor 40 is then actuated in a linear manner such that the opening 40A is aligned with the die axis 48, beneath the die. The tablet can then be ejected by applying an ejection force to the tablet such that it is dislodged from the die and falls into opening 40A. The ejection force can be applied by a second actuation of the punch 24 by the motor 28. Alternatively, a separate ejection mechanism can be provided at ejection station 6 as necessary.

The tablet falls through the die floor 40 and is caught in the opening 40A. In this condition the tablet is loosely held beneath the die. The die floor 40 may be moved to a further position such that the tablet is entrapped in the recess beneath the die as necessary.

With the tablet in the opening 40A, the die assembly is moved to the ejection station 6, where the die floor 40 is actuated to allow removal of the tablet. In one embodiment, the tablet receptacle is be arranged beneath the guide in use and the die floor is actuated to allow the tablet to fall under gravity into the receptacle. In this arrangement, the die assembly or guide may have a lower plate arrangement, comprising a further opening to allow tablets to drop into the container as the die passes there-over.

In an alternative embodiment, the tablet ejection/removal station 6 may comprise a tablet picker, which may for example comprise a vacuum source and a suction cup or other vacuum removal arrangement. The suction cup or head may be moveable for example on a rail or else by a robotic arm between the die and the receptacle to allow tablet removal in a more controlled manner.

The empty die then passes to the weighing station 5 to restart the process, whereby the weight of the die assembly is again checked to confirm that it is indeed empty.

The above process can be repeated in a cyclic manner until the desired number of tablets has been produced. Furthermore, two or more die carriages 8 are provided such that one die assembly can be filled whilst another die is undergoing a pressing operation in order to help expedite tablet production.

Turning now to FIG. 5, there is shown a further example of a system 100 according to the invention. In this example, the concept of providing a moveable die assembly has been applied to a generally linear system in which a single die assembly 102 of the type described above may move back and forth between a compaction station 104 and a filling station 106. Whilst negating some of the benefits of a circular track system, the embodiment of FIG. 5 allows a more compact system that allows small numbers of tablets to be produced in an automated and/or controlled manner. In particular, the process of filling and/or emptying the die may be controlled such that minimal manual interaction is required.

In the example of FIG. 5, the die guide comprises two opposing guide members 108 arranged to constrain the die assembly 102 there-between such that the die is moveable linearly along the guide. In this embodiment, a tablet removal/collection station 110 is also provided. The removal station 110 in this example is provided along the guide at a location between the filling and compaction stations. However alternative relative positions of those stations along the guide can be selected as required. The tablet removal station comprises a receptacle arranged to receive the tablet once formed, in the manner described above. Furthermore the filling station 106 in this embodiment comprises a powder pipette 112 system but may comprise any other conventional powder dispensing/metering system as described above.

The sequence of events during operation of the filling station 106 in the system of FIG. 5 is as follows:

1) Die assembly to Filling station.

2) Powder pipette to Powder Reservoir

3) Fill powder pipette

4) Powder pipette to die

5) Empty powder pipette

6) Powder pipette returns to station

The filled die assembly 102 then moves to the compaction station 104 and the punch/press is actuated in accordance with the methods described herein. Once compaction is complete the die floor is actuated and the tablet press then undergoes an ejection stroke to displace the tablet into the ejection opening 40A in the die floor aligned beneath the punch.

The die assembly then moves to the removal station 110, for example, whilst still with the ejection opening exposed, and a tablet removal sequence is performed as follows:

1) Vacuum applied to ejection space

2) Vacuum head 114 picks up tablet

3) Move to product reservoir 116

4) Vacuum ceased to deposit tablet

5) Vacuum head returns to station

The die assembly subsequently moves to the filling station 106 to end the tablet production process or else to repeat the steps described above, dependent on the number of tablets to be produced.

In any of the embodiments described above, the controller may maintain a count of tablets produced or cycles performed in order to determine whether the desired number of tablets has been produced.

The operation and control of the tablet press by a controller will now be described in further detail with reference to FIGS. 2 to 4. To this end, the tablet press 10 comprises one or more processors, typically in the form of a microchip, and a data store or memory for controlling actuation of the punch by the motor 28 in accordance with user inputs.

The tablet press further comprises means for establishing a data connection with a separate computing means. In this embodiment, an electrical connector 50 in the tablet press 10 is connected by a lead 52 to a laptop 54. Additionally, or alternatively, a wireless data link may be established in different embodiments by providing the tablet press with conventional wireless data transfer hardware, such as may be required for data transmission/reception by radio using, for example Wi-Fi, GSM, 3G, Bluetooth or other communication standards. Whilst a laptop 54 is shown in FIG. 1, the reader will appreciate that numerous forms or alternative computational equipment exist which could be substituted, such as, for example, a desktop personal computer, PDA, mobile/cell phone, computer tablet or similar.

The operating system for the tablet press system comprises two parts. The processor in the tablet press 10 itself is provided with machine-readable code in the form of firmware. The PC 54 is provided with software that controls the display of an on-screen user interface, an example of which is shown in FIG. 4.

The tablet press initialises by actuating the motor 28 such that the punch is moved to a fully retracted position. This position serves as the datum position for the machine. Any settings stored in the memory from a previous instance of use are retrieved from the memory.

Once the tablet press firmware establishes data communication with the PC, tablet pressing parameters can be set at or altered using the user interface 56 on the PC. A tablet description (identifier) can also be input by the user via the interface. The parameters that are required for entry or upload by a user comprise the following:
a. Compaction mode: Either fixed thickness or fixed load modes are available. In fixed thickness mode, the contents of the die will be compacted until the die reaches a specified position. In fixed load mode, the compaction continues until a specified load is applied to the punch (as determined by the load cell 26);
b. Target thickness or load: The desired tablet thickness or maximum load, depending on the mode set in (a) above;
c. Compaction speed;
d. Die diameter: This is for information and is shown on the header of exported reports, but, in this embodiment, has no bearing on the compaction itself;
e. Die thickness: The total thickness of the die, which is used to calculate positions during the compaction routine.

The above data and or instructions are entered by the user using the buttons and alphanumeric character entry boxes in the region 58 of the graphical user interface 56.

Before a compaction can be started, the position of the bottom of the die is established by the firmware. The use of different dies in the press may change this parameter. The determination of the location of the floor of the die relative to the datum position may achieved by moving an empty die to the pressing station and starting the ‘new size’ procedure. The firmware controls actuation of the punch 24 downwards until it touches the die floor member 40. The distance of travel and/or position of the die floor 40 relative to the datum position is stored. The punch 24 then retracts out of the die 38.

The die filling sequence described above is then undertaken. Once the die and powder therein is correctly positioned in the tablet press 10, the compaction stage can begin. The compaction is started automatically by the controller. The controller is able to calculate a number of positions comprising:
i. Stop position: this is used in ‘fixed thickness mode’, and is defined as the bottom-of-die reference position minus the target tablet thickness;
ii. Compaction speed position: this is the position at which the punch switches from full speed movement to compaction speed, and is defined as a predetermined distance above or below the top of the die;
iii. Return position: The position the punch returns to after the compaction, defined as a predetermined distance above the top of the die.

The firmware then controls operation of the motor 28 in conjunction with the digital encoder such that the punch 24 moves downwards at full speed until the compaction speed position (as calculated at stage 62) is reached. This position is determined by a control loop, at which point the firmware controls the change in operation of the motor 28 to operate the punch at the compaction speed, which is typically constant for the compaction phase of the process.

The punch 24 continues its downward movement such that it comes into contact with powder in the die. The change to compaction speed also triggers a signal from the tablet press to the PC such that the PC software will start plotting a graph of load against position for the punch in window 60 of the user interface 56. The load reading is taken from the load cell 26 and the position is determined by the angular position of the motor in accordance with the digital encoder. This information can be recorded for each tablet.

Further downward movement of the punch compacts the powder in the die. Compaction continues until either: the stop position (calculated in (i) above) is reached, when in the ‘fixed thickness’ mode; or, the target load (set in b above) is reached, when in the ‘fixed load’ mode. In either mode, the compaction will be aborted if the load cell is overloaded. The punch then stops. The punch may be held for a predetermined period at this position. The motor is controlled to retract the punch at compaction speed for a predetermined distance, such as, for example 2 mm. Graph plotting and/or load recordal then ends. The motor then actuates the punch in the retraction direct at full speed to the datum position.

During ejection, the die floor 40 is first actuated such that the opening 40A is beneath the die. The punch initially runs downward at full speed until the compaction speed position is reached. The punch then continues at compaction speed to eject the tablet. However, instead of monitoring, the compaction criteria described above, upon ejection the controller instead determines whether the punch end 25 has reach end has reached the location of the bottom of the die (i.e. the location at which the floor member 40 was previously present). Once the bottom of the die is reached, the punch reverses to the return position.

The die assembly is then moved away from the tablet press 10. The tablet press and associated firmware now return to a ready condition in which the tablet press is able to start the next compaction automatically, upon receipt of the next full die assembly therein, or else to pause for settings to be altered.

Whilst the above embodiments make use of both on-board firmware and external computer software, it is to be noted that the tablet pressing process can be carried out entirely under the control of the machine firmware if necessary. The user may enter the necessary data using the keys 34 in response to simple prompts on display screen 32. However it is felt that the combined use of basic firmware and more advanced software running on a connected computer offers useful functionality that would otherwise add expense to a stand-alone tablet press system. However any, or any combination, of on-board and remote or external data processing is envisaged as being possible based on the foregoing description. Any reference to a ‘controller’ herein may refer to one or more processors arranged onboard the tablet press, onboard another station in the system, or else in communication therewith to achieve the desired control function.

It will be appreciated that the system described above comprises sensors to determine the die assembly location and/or other operational parameters. The controller receives sensor readings and may control cessation of the process in the event that one or more sensor readings achieve or exceed a predetermined threshold value determined to be indicative of an erroneous event. In such an event, one or more alarms or error messages may be output. This may be in addition to the compaction readings described above, which may be stored as described above. In the case of batch production, the compaction parameters for the individual tablets may be recorded and/or summary (or average) data for the batch may be determined.

The present invention is particularly advantageous since individual or small batches of tablets can be produced under known compaction parameters which have been entered by a user. The compaction parameters for each tablet produced can be individually set by a user. Such a system can be used to improve reproducibility and remove possible manual errors in small tablet production batches. This is beneficial is small batches of tablets are to be produced according to predetermined settings or else to predetermined variations in settings.

1. A tablet press system comprising:
a die for receiving a powder to be compacted and
a press member for compacting the powder in use within the die, the press member being actuable along a first axis under the control of an electronic controller,
wherein the die is moveable between a first location in which the die is aligned with the first axis for compaction and a plurality of further locations spaced therefrom, and comprising an combination of a filling, weighing and/or a tablet removal station,
wherein the tablet press system further comprises a die guide, extending between the first and further locations, and wherein motion of the die along the die guide is electrically powered.

2. A tablet press system according to claim 1, wherein the first location comprises a compacting station and the further location comprises a die filling station.

3. (canceled)

4. (canceled)

5. A tablet press system according to claim 1, wherein the die guide comprises one or more elongate guide formation and the die is constrained to a single degree of freedom of motion along the guide formation.

6. A tablet press system according to claim 5, wherein the die is constrained between a pair of substantially parallel die guide formations.

7. A tablet press system according to claim 1, wherein the die guide is arranged to provide a closed circuit between the first and further location.

8. A tablet press system according to claim 1, wherein the die movement is powered by an electric die actuator.

9. A tablet press system according to any one of claims 1, wherein the die guide comprises an electrical conductor for powering movement of the die.

10. A tablet press system according to claim 1, wherein the die movement is automatically controlled by the controller.

11. A tablet press system according to claim 10, wherein the controller is arranged to move the die between the first axis and the one or more further locations in a predetermined sequence.

12. A tablet press system according to claim 10, further comprising one or more die position sensors, the controller being arranged to control actuation of the press member upon determining the presence of the die at the first location.

13. A tablet press system according to claim 1 comprising one or more sensors arranged to determine any or any combination of the presence, volume and/or compaction state of powder material in the die.

14. A tablet press system according to claim 1, comprising a releasable lock or stop member for releasably retaining the die at the first location.

15. A tablet press system according to claim 1, wherein the first location comprises a tablet press having a base, the press member being held relative to the base by a spacer depending from the base, wherein the spacer is moveable relative the base under the control of a press actuator.

16. A tablet press system according to claim 15, wherein the spacer comprises one or more pillar formation.

17. A tablet press system according to claim 1, comprising an electrical actuator for movement of the press member.

18. A tablet press system according to claim 17, wherein the press actuator comprises a DC motor.

19. A tablet press system according to claim 18, wherein the press actuator is digitally controlled by the controller.

20. A tablet press system according to claim 1, wherein the controller controls motion of the press member in response a desired applied load to the powder or a desired tablet thickness set by a user.

21. A tablet system according to claim 1, comprising a load sensor for recording the load applied to the powder by the press member during compaction.

22. A tablet system according to claim 21, wherein the controller records the maximum load on the press member during a compaction cycle.

23. A tablet system according to claim 1, comprising a plurality of dies arranged to move under the control of the controller between the first and further locations concurrently.

24. A tablet system according to claim 1, wherein the further location comprises separate filling and weighing stations such that a weight of powder in the die may be checked after filling and prior to compaction.
